(19) United States
(12) Patent Application Publication
(10) Pub. No.: US 2021/0402985 A1
(43) Pub. Date: Dec. 30, 2021

(54) Vehicle Control Device

(71) Applicant: Hitachi Automotive Systems, Ltd., Hitachinaka-shi, Ibaraki (JP)

(72) Inventors: Satoshi MATSUDA, Hitachinaka-shi (JP); Masashi SEIMIYA, Hitachinaka-shi (JP); Akitoshi MIYAZAKI, Hitachinaka-shi (JP)

(21) Appl. No.: 17/279,430

(22) PCT Filed: Aug. 8, 2019
(86) PCT No.: PCT/JP2019/031323

§ 371 Date: Mar. 24, 2021

(30) Foreign Application Priority Data
Sep. 27, 2018 (JP) 2018-181554

(51) Int. Cl. B60W 30/06; B60T 7/22; G08G 1/16; B62D 15/02

(52) U.S. Cl. CPC B60W 30/06; B60T 7/22; G08G 1/168; B60W 2554/20; B60T 2201/10; B60W 2540/215; B62D 15/0285

(57) ABSTRACT

Provided is a vehicle control device that can reduce discomfort of an occupant during parking control. The vehicle control device 10 includes a route calculator 11 that calculates a parking route of a vehicle, a travel controller 12 that makes the vehicle travel along the parking route, and a route selector 13 that selects either an original parking route or a new parking route when the vehicle traveling along the parking route stops at a stop position before a turn-back position, the new parking route being calculated at the stop position. The travel controller 12 makes the vehicle travel from the stop position along the parking route selected by the route selector 13.

### TECHNICAL FIELD

The present disclosure relates to a vehicle control device mounted on an automobile to perform parking control.

### BACKGROUND ART

There is known an invention relating to a parking assistance device that assists a driver driving a vehicle in parking operation (see Patent Literature 1 below). The parking assistance device described in Patent Literature 1 includes parking assistance start instruction means, object position detection means, detection information storage means, guidance means, and standby state return instruction means (see the same Patent Literature, claim 1, etc.).

The parking assistance start instruction means instructs the start of parking operation assistance. The object position detection means detects a position with respect to the vehicle of an object that exists in the vicinity of the vehicle. The detection information storage means collects and stores detection information obtained from the object position detection means when the parking assistance start instruction means instructs the start of the parking operation assistance.

The guidance means makes the parking operation assistance be in a standby state from when the start of the parking operation assistance is instructed until a driver stops the vehicle, releases the standby state when the driver stops the vehicle, and sets a target parking position according to the stop position. In addition, the guidance means provides guidance for assisting the parking operation based on the target parking position and the detection information stored in the detection information storage means.

When the operation for returning to the standby state again is instructed after the standby state is released, the standby state return instruction means erases the setting result of the target parking position corresponding to the stop position, and holds the detection information stored in the detection information storage means until the time of stopping and makes the assistance return to the standby state again.

According to this conventional parking assistance device, the control can be reliably returned to the standby state after the standby state is released. Therefore, even if the vehicle is accidentally stopped, the control does not need to be started from the beginning. The parking assistance can be continuously provided, and highly convenient driving operation assistance can be provided (see the same Patent Literature, paragraph 0011, etc.).

### CITATION LIST

### Patent Literature

PTL 1: JP 2005-193698 A

### SUMMARY OF INVENTION

### Technical Problem

In the conventional parking assistance device described above, it is conceivable that the vehicle approaches an obstacle such as a wall while parking assistance guidance is provided, and the driver of the vehicle feels danger and stops the vehicle by brake operation.

In this case, in the conventional parking assistance device, the standby state is released by the guidance means. After that, when the driver gives an instruction to return to the standby state again, the standby state return instruction means returns the control to the standby state again and the control is continued (see Patent Literature 1, paragraph 0047-0048, etc.).

However, in this conventional parking assistance device, even if the driver feels danger and stops the vehicle, there is a possibility that the vehicle is guided in a direction further approaching the obstacle. In this case, the driver may feel discomfort due to the discrepancy between the intention of the driver and the moving direction of the vehicle.

The present disclosure provides a vehicle control device that can reduce discomfort of an occupant during parking control.

### Solution to Problem

An aspect of the present disclosure is a vehicle control device including: a route calculator that calculates a parking route of a vehicle; a travel controller that makes the vehicle travel along the parking route; and a route selector that selects either an original parking route or a new parking route when the vehicle traveling along the parking route stops before a turn-back position, the new parking route being calculated at the stop position. Further, the travel controller makes the vehicle travel from the stop position along the parking route selected by the route selector.

### Advantageous Effects of Invention

According to an aspect of the present disclosure, it is possible to provide a vehicle control device that can reduce discomfort of an occupant during parking control.

### BRIEF DESCRIPTION OF DRAWINGS

FIG. 1 is a schematic configuration diagram of a vehicle equipped with a vehicle control device according to an embodiment of the present disclosure.

FIG. 2 is a functional block diagram of the vehicle control device that is mounted on the vehicle shown in FIG. 1.

FIG. 3 is a plan view showing an example of parking control of the vehicle by the vehicle control device shown in FIG. 2.

FIG. 4 is a flow diagram showing an example of the parking control of the vehicle by the vehicle control device shown in FIG. 2.

FIG. 5 is a flow diagram of the parking control in parking assistance performed by the vehicle control device shown in FIG. 4.

FIG. 6 is a plan view showing a state in which the vehicle has stopped before a turn-back position shown in FIG. 3.

FIG. 7 is a plan view showing a return route for returning the vehicle to a parking route from a stop position shown in FIG. 6.

FIG. 8 is a plan view showing a return route for returning the vehicle to a parking route from a stop position shown in FIG. 6.

### DESCRIPTION OF EMBODIMENT

Hereinafter, an embodiment of a vehicle control device according to the present disclosure is described with reference to the drawings.

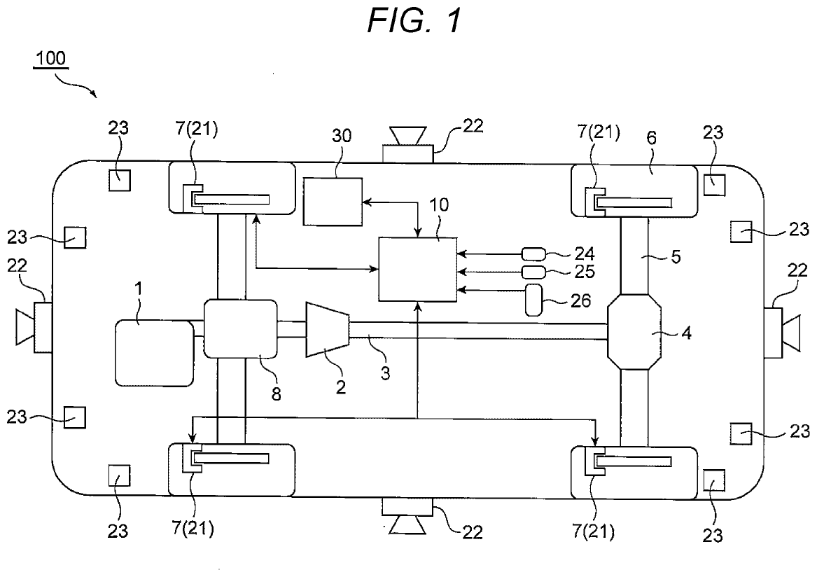

FIG. 1 is a schematic configuration diagram of a vehicle 100 equipped with a vehicle control device 10 according to an embodiment of the present disclosure. The vehicle 100 includes, for example, a cylinder injection gasoline engine 1 as a power source for traveling and an automatic transmission 2 that can be connected to and detached from the engine 1.

Note that FIG. 1 shows an example of the vehicle 100 on which the vehicle control device 10 is mounted, and does not limit the configuration of the vehicle 100. For example, the vehicle 100 may use a motor or both an engine and a motor as a driving power source instead of the engine 1. Further, the vehicle 100 may adopt a continuously variable transmission (CVT) instead of the automatic transmission 2.

The vehicle 100 is a rear-wheel drive vehicle that has a typical configuration including, for example, a propeller shaft 3, a differential gear 4, a drive shaft 5, four wheels 6, a hydraulic brake 7 with a wheel speed sensor 21, and an electric power steering device 8.

The vehicle 100 includes the vehicle control device 10. The vehicle control device 10 is a device that controls devices, actuators, and instruments mounted on the vehicle 100. The vehicle control device 10 as well as devices, actuators, and instruments including sensors described later are configured to be able to exchange signals and data through in-vehicle local area network (LAN) and controller area network (CAN) communication. The vehicle control device 10 is, for example, an electronic control unit (ECU), and is a parking assistance ECU and a vehicle control ECU.

The vehicle 100 includes, for example, a plurality of wheel speed sensors 21, a plurality of monocular cameras 22, and a plurality of sonars 23, as sensors. Each of the wheel speed sensors 21 generates a pulse waveform according to the rotation of each of the wheel and transmits the waveform to the vehicle control device 10. The plurality of monocular cameras 22 and the plurality of sonars 23 are, for example, external recognition sensors that are arranged at the front, rear, and sides of the vehicle 100 and detect information around the vehicle.

Further, the vehicle 100 has sensors 24, 25, and 26 as operation quantity detection sensors for detecting the operation quantity (steering angle) of a brake pedal, an accelerator pedal, and a steering wheel, respectively. In addition to the above sensors, the vehicle 100 may include, for example, a sensor, such as a stereo camera or light detection and ranging/laser imaging detection and ranging (LIDAR), as an external recognition sensor. Further, the vehicle 100 may be provided with a seating sensor that detects the presence of an occupant.

The vehicle control device 10 acquires information on the outside of the vehicle 100, the operation quantities of the brake pedal, the accelerator pedal, and the steering wheel in different components of the vehicle 100, and so on, from the various sensors described above. Based on the acquired information, the vehicle control device 10 transmits command values to realize control, such as following the preceding vehicle, maintaining the center of the white line, preventing lane departure, providing parking assistance, and so on, to the engine 1, the automatic transmission 2, the brake 7, the electric power steering device 8, and others.

The vehicle 100 includes, for example, a display device 30. The display device 30 is, for example, a liquid crystal display device provided with a touch panel, and is an image information output device on which an image is displayed by the vehicle control device 10 to notify the occupants of the information. Further, by being provided with the touch panel, the display device 30 also functions as an information input device with which the occupant of the vehicle 100 inputs information to the vehicle control device 10.

Further, the vehicle 100 includes, for example, a microphone and a speaker which are not shown. The microphone is a voice information input device for the occupant of the vehicle 100 to input information by voice input to the vehicle control device 10. The speaker is a voice information output device through which the vehicle control device 10 notifies the occupant of the vehicle 100 of information with electronic sound or voice.

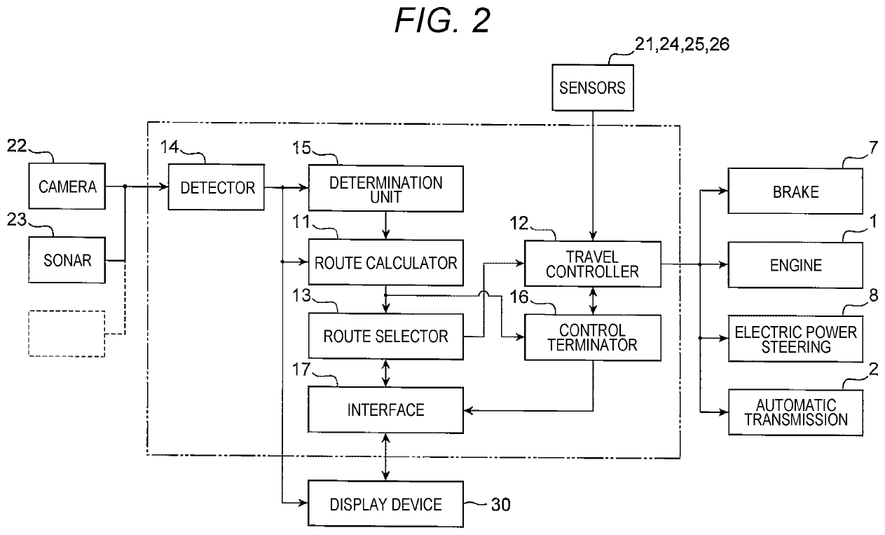

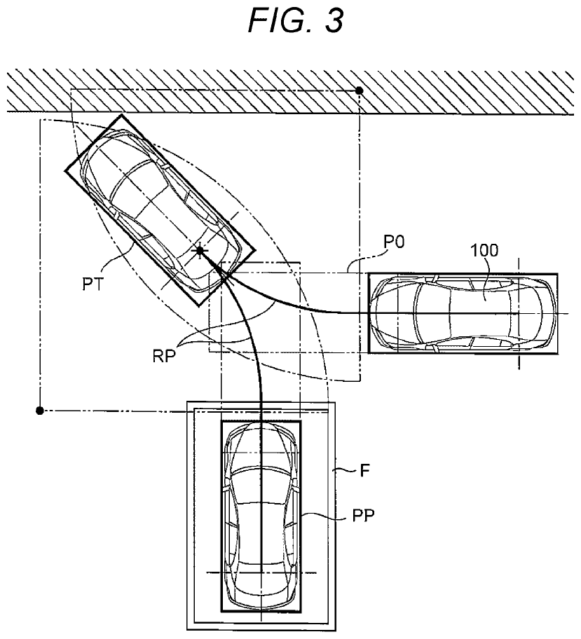

FIG. 2 is a functional block diagram of the vehicle control device 10 of the present embodiment. FIG. 3 is a plan view showing an example of parking control of the vehicle 100 by the vehicle control device 10. Each component of the vehicle control device 10 is constituted of, for example, a computer unit including a central processing unit (CPU), a storage device such as a memory, a computer program stored in the storage device, and an input/output unit for transmitting and receiving data and signals, and others. Although the details are described later, the vehicle control device 10 of the present embodiment is characterized by the following configuration.

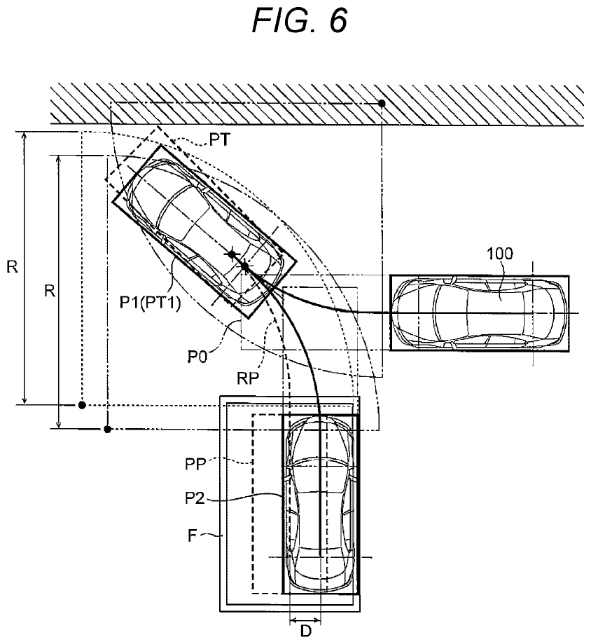

The vehicle control device 10 includes a route calculator 11, a travel controller 12, and a route selector 13. The route calculator 11 calculates a parking route RP of the vehicle 100. The travel controller 12 makes the vehicle 100 travel along the parking route RP. When the vehicle 100 traveling along the parking route RP stops at a stop position P1 (see FIG. 6) before a turn-back position PT, the route selector 13 selects the original parking route RP or a new parking route calculated from or the stop position P1. Then, the travel controller 12 makes the vehicle 100 travel from the stop position P1 along the original parking route RP or the new parking route selected by the route selector 13.

Hereinafter, the configuration of individual components of the vehicle control device 10 of the present embodiment are described in more detail. In addition to the route calculator 11, the travel controller 12, and the route selector 13 described above, the vehicle control device 10 includes, for example, a detector 14, a determination unit 15, a control terminator 16, and an interface 17.

The detector 14 detects an obstacle around the vehicle 100 based on the detection results of the external recognition sensors such as the monocular cameras 22 and the sonars 23. The travel controller 12 can be configured to stop the vehicle 100 at the stop position before the obstacle when, for example, the obstacle is detected by the detector 14 in the parking route RP on which the vehicle 100 travels. In this case, the travel controller 12 can be configured to make the vehicle 100 travel from the stop position on the parking route RP when, for example, the obstacle is no longer detected by the detector 14.

The determination unit 15 determines whether or not the vehicle 100 traveling on the parking route RP can return to the original parking route RP by setting the stop position P1 of the time when the vehicle stops before the turn-back position PT, as a new turn-back position PT1. Each of the turn-back positions PT and PT1 is a connection point or boundary point between a forward route and a backward route included in the parking route. The forward route is a route in which the vehicle 100 moves forward, and the backward route is a route in which the vehicle 100 moves backward. That is, each of the turn-back positions PT and PT1 is a point where the forward or reverse movement of the vehicle 100 traveling on the parking route is switched.

More specifically, the determination unit 15 can determine whether or not the vehicle can return to the original parking route RP by using, for example, the following index. The index for this determination is at least one of, for example, the stop position of the vehicle 100, the yaw angle of the vehicle 100 at the stop position, a travel route by which the vehicle 100 returns to the original parking route RP, the minimum turning radius of the vehicle 100, the obstacles around the vehicle 100, the parking frame, and the road widths around the vehicle 100.

The route calculator 11, the route selector 13, and the travel controller 12 are configured to perform the following operations when, for example, the determination unit 15 determines that the vehicle can return to the original parking route RP. The route calculator 11 does not calculate the new parking route, and the route selector 13 selects the original parking route RP. Alternatively, the route calculator 11 calculates the new parking route, but the route selector 13 selects the original parking route RP. The travel controller 12 makes the vehicle 100 travel using the stop position P1 as the new turn-back position PT1 and returns the vehicle to the original parking route RP.

Further, the route calculator 11, the route selector 13, and the travel controller 12 are configured to perform the following operations when, for example, the determination unit 15 determines that the vehicle cannot return to the original parking route RP. The route calculator 11 calculates the new parking route from the stop position P1. The route selector 13 selects a more efficient parking route from the original parking route RP and the new parking route. The travel controller 12 makes the vehicle 100 travel along the original parking route RP or the new parking route selected by the route selector 13 after the interface 17 notifies the occupants of the selection result of the parking route.

More specifically, the route selector 13 calculates the efficiency of the parking route based on, for example, at least one of the number of turn-back positions included in the parking route, the time required for the vehicle 100 to travel on the parking route, and the length of the parking route. That is, in order to calculate the efficiency of the parking route, one of the above indices may be used. Alternatively, any combination of two or more of the above indices or a combination of a plurality of weighted indices may be used. The above-described indices are examples, and the efficiency of the parking route may be calculated using other indices.

The interface 17 is configured to notify the occupant of the vehicle 100 of the original parking route RP and the new parking route calculated by the route calculator 11. More specifically, the interface 17 notifies the occupant by, for example, displaying a plurality of parking routes calculated by the route calculator 11 on the display device 30. Further, the interface 17 may notify the occupant of detailed information of the plurality of parking routes through, for example, voice via the speaker mounted on the vehicle 100.

Further, the interface 17 is configured to allow the occupant to input the selection result of the original parking route RP and the new parking route. More specifically, the interface 17 is configured to allow the selection result to be input by, for example, displaying options on the display device 30 and the occupant selecting the options through a touch panel. Further, the interface 17 may be configured to allow the selection result to be input by, for example, recognizing the voice of the occupant through a microphone mounted on the vehicle 100.

Further, the interface 17 is configured to notify the occupant of information on the parking efficiency of the original parking route RP and the new parking route calculated by the route calculator 11 through, for example, the display device 30 or the speaker.

The route selector 13 can be configured to select the original parking route RP or the new parking route according to, for example, the selection result of the parking route made by the occupant input to the interface 17.

The control terminator 16 is configured to terminate the control by the travel controller 12 in a state of the vehicle 100 being stopped and notify the occupant of the vehicle 100 of the termination of control when, for example, the vehicle 100 cannot travel the original parking route RP and the route calculator 11 cannot calculate the new parking route. More specifically, the control terminator 16 is configured to notify the occupant of the termination of control by, for example, displaying information on the termination of control on the display device 30 through the interface 17. Further, the control terminator 16 may be configured to notify the occupant of the termination of control through, for example, the speaker mounted on the vehicle 100.

The travel controller 12 can be configured to return the vehicle 100 to a start position of the parking route RP when, for example, the vehicle 100 cannot travel the original parking route RP, there is no occupant on the vehicle 100, and the route calculator 11 cannot calculate the new parking route.

Hereinafter, parking control of the vehicle 100 by the vehicle control device 10 of the present embodiment is described.

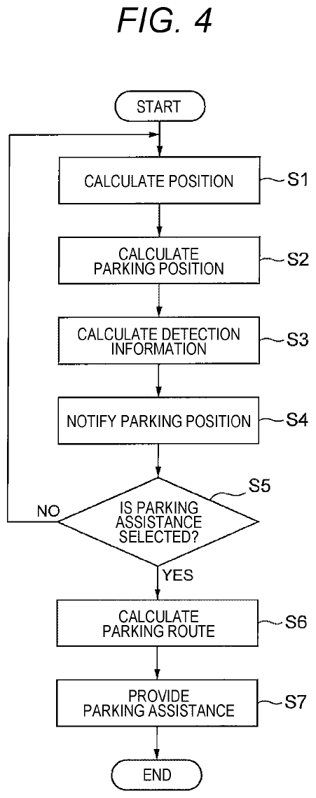

FIG. 4 is a flow chart showing an example of parking control of the vehicle 100 by the vehicle control device 10 shown in FIG. 2.

In step S1, the vehicle control device 10 calculates the position of the vehicle 100. For example, the travel controller 12 calculates the speed of the vehicle 100 based on the output value of the wheel speed sensor 21, calculates the traveling direction of the vehicle 100 based on the output value of the sensor 26, and calculates the coordinate position of the vehicle 100 based on these calculation results.

In the following step S2, the vehicle control device 10 calculates a parking position PP of the vehicle 100. For example, the detector 14 analyzes the environmental information around the vehicle 100 acquired by the monocular cameras 22 and the sonars 23, and calculates the parking position PP in which the vehicle 100 can park.

In the following step S3, the vehicle control device 10 calculates the detection information. For example, the detector 14 analyzes the environmental information around the vehicle 100 acquired by the monocular cameras 22 and the sonars 23, and detects an obstacle. When the obstacle is detected, the detector 14 calculates the coordinate information of the obstacle.

In the following step S4, the vehicle control device 10 notifies the occupant of the vehicle 100 of the parking position PP. For example, the detector 14 superimposes the parking position PP calculated in step S2 on the information around the vehicle 100 and displays the superimposed image on the display device 30. The occupant of the vehicle 100 stops vehicle 100, for example, to start parking assistance.

In the following step S5, the vehicle control device 10 determines whether or not the parking assistance is selected.

For example, when a parking assistant button of the vehicle 100 is not pressed by the occupant of the vehicle 100, the detector 14 determines that the parking assistance is not selected (NO) and the process returns to step S1. On the other hand, for example, when the parking assistant button of the vehicle 100 is pressed by the occupant of the vehicle 100, the detector 14 determines that the parking assistance is selected (YES). Then, the process proceeds to step S6. In step S6, the vehicle control device 10 calculates the parking route RP from a stop position P0 of the vehicle 100 to the parking position PP.

In the following step S7, the vehicle control device 10 executes the parking control to assist the parking of the vehicle 100. For example, when the travel controller 12 detects that the occupant of the vehicle 100 has released the brake pedal based on the output value of the sensor 24 that detects the operation quantity of the brake pedal, the travel controller 12 automatically controls the brake 7, the engine 1, the electric power steering device 8, the automatic transmission 2, and others to make the vehicle 100 automatically travel along the parking route RP.

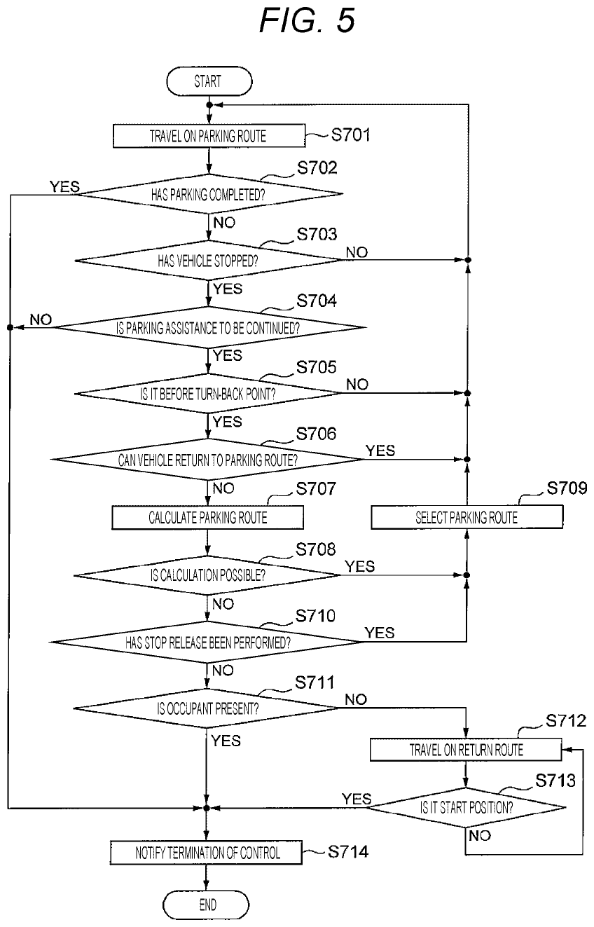

FIG. 5 is a flow chart showing an example of the parking control in the parking assistance executed by the vehicle control device 10 in step S7 shown in FIG. 4. When the parking assistance is started in step S7 shown in FIG. 4, the parking control shown in FIG. 5 is started. In step S701, as shown in FIG. 3, the travel controller 12 turns the steering wheel to the right using the electric power steering device 8, and makes the vehicle 100 travel from the start position P0 along the parking route RP and to turn to the right.

In the following step S702, the travel controller 12 determines whether or not the vehicle 100 has reached the parking position PP and has completed the parking. If the vehicle 100 has not reached the parking position PP and has not completed the parking (NO), the process proceeds to step S703.

In step S703, the travel controller 12 determines whether or not the vehicle 100 has been stopped by the occupant by, for example, the wheel speed sensor 21 or the sensor 24 that detects the operation quantity of the brake pedal. When the travel controller 12 determines that the vehicle 100 has not been stopped by the occupant (NO), the process returns to step S701 and continues the traveling of the vehicle 100.

By repeating the step S701 to step S703, the vehicle 100 is controlled by the travel controller 12 to automatically travel, and travels from the stop position P0 along the forward route and stops at a turn-back position PT. When the vehicle 100 stops at the turn-back position PT, the travel controller 12 operates the brake 7 to maintain the vehicle 100 to be in a stopped state, and shifts the automatic transmission 2 to the reverse gear. Further, the travel controller 12 moves the vehicle 100 backward from the turn-back position PT along the backward route of the parking route RP, and to reach the parking position PP by controlling the steering wheel by the electric power steering device 8.

In step S702, when the vehicle 100 is stopped near the parking position PP, the travel controller 12 determines that the parking is completed (YES), and shifts the automatic transmission 2 to the parking gear. Then, the process proceeds to steps S714.

In step S714, for example, the vehicle control device 10 terminates the parking control of the travel controller 12 by the control terminator 16, and notifies the occupant of the vehicle 100 of the completion of parking through the interface 17, the display device 30, and the speaker.

However, as described above, the vehicle 100 may stop when the occupant of the vehicle 100 steps on the brake pedal in the middle of the parking route RP before the vehicle 100 reaches the parking position PP.

FIG. 6 is a plan view showing a state in which the vehicle 100 is stopped by the occupant of the vehicle 100 stepping on the brake pedal before the turn-back position PT shown in FIG. 3. In the present embodiment, the parking route RP of the vehicle 100 is shown as, for example, the locus of the center of an axle of the rear wheels.

In the example shown in FIG. 3, the vehicle 100 traveling along the parking route RP moves forward while turning to the right to the vicinity of an obstacle such as a wall, and reaches the turn-back position PT just before the obstacle. In the above case, the occupant of the vehicle 100 may feel danger of the vehicle 100 colliding with the obstacle before the vehicle 100 reaches the turn-back position PT, and may stop the vehicle 100 by, for example, stepping on the brake pedal.

If the occupant steps on the brake pedal before the vehicle 100 reaches the turn-back position PT, the vehicle 100 may stop at the stop position P1 before the turn-back position PT. Then, in step S703, the travel controller 12 determines that the occupant has stopped the vehicle 100 (YES) based on, for example, the output values from the wheel speed sensor 21 and the sensor 24 that detects the operation quantity of the brake pedal. Then, the process proceeds to step S704.

In step S704, the vehicle control device 10 notifies the occupant through, for example, the interface 17, and the display device 30 or the speaker that the vehicle 100 has stopped during parking assistance, and confirms whether or not to continue the parking assistance. For example, when the occupant selects to stop the parking assistance by using the touch panel or the microphone of the display device 30, the process proceeds to step S714 and the vehicle control device 10 notifies the occupant of the termination of control and terminates the parking control. On the other hand, if the occupant selects to continue the parking assistance, the vehicle control device 10 proceeds the process to step S705.

Note that step S704 can be omitted.

In step S705, the vehicle control device 10 determines, for example, by the determination unit 15, whether or not the vehicle 100 has stopped before the turn-back position PT of the parking route RP that has been calculated first. When, for example, the determination unit 15 determines that the vehicle 100 has not stopped before the turn-back position PT (NO), that is, the vehicle has stopped beyond the turn-back position PT, the vehicle control device 10 returns the process to step S701 and makes the vehicle 100 travel along the original parking route RP by the travel controller 12. On the other hand, for example, when the determination unit 15 determines that the vehicle 100 has stopped before the turn-back position PT, the process proceeds to step S706.

In step S706, the vehicle control device 10 determines, for example, by the determination unit 15, whether or not the stop position P1 before the turn-back position PT can be set as the new turn-back position PT1 to return to the original parking route RP. For example, as shown in FIG. 6, it is assumed that the stop position P1 before the turn-back position PT of the original parking route RP is set as the new turn-back position PT1 and the steering wheel is turned to the left at the new turn-back position PT1 to move the vehicle backward.

For example, in the case of the vehicle yaw angle at the parking position PP being 90 degrees with respect to the vehicle yaw angle at the start position P0, when the vehicle moves backward while turning based on the backward route information of the original parking route RP, an error D occurs between the parking position PP of the original parking route RP and an actual parking position P2.

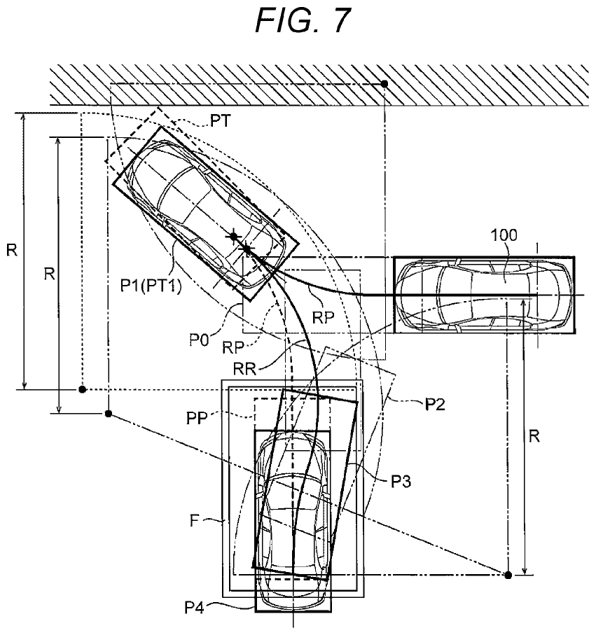

FIG. 7 shows a plan view showing, for example, in the case of the vehicle yaw angle at the parking position PP being 90 degrees with respect to the vehicle yaw angle at the start position P0, a return route RR for returning the vehicle to the original parking route RP by moving the vehicle 100 backward from the stop position P1 before the turn-back position PT while turning the vehicle at a turning radius R equal to that of the original parking route RP. In the example shown in FIG. 7, in order to reduce the error D shown in FIG. 6 and return the vehicle 100 to the parking route RP, the vehicle 100 is moved backward up to a position P2 where the yaw angle of the vehicle 100 becomes larger than 90 degrees with respect to the start position P0.

Further, at the position P2, the steering wheel is turned to the right, and the vehicle 100 is moved backward with the same turning radius R from the position P2. Then, at a position P3, the rear end of the vehicle 100 reaches the rear end of a parking frame F, but the yaw angle of the vehicle 100 is larger than 90 degrees with respect to the yaw angle of the vehicle 100 at the start position P0, and the vehicle is in a tilted state with respect to the parking frame F. Note that the parking frame F is a rectangular frame-shaped display on the road indicating a space that can be parked.

From this position P3, when the vehicle 100 is moved backward while turning with the same turning radius R, the yaw angle of the vehicle 100 approaches 90 degrees with respect to the yaw angle of the vehicle 100 at the start position P0, and the tilt of the vehicle 100 with respect to the parking frame F gradually decreases. Then, at a position P4, the yaw angle of the vehicle 100 becomes equal to the yaw angle of the vehicle 100 at the parking position PP, but the rear end of the vehicle 100 protrudes from the rear end of the parking frame F.

As shown in FIG. 7, for example, the determination unit 15 calculates the return route RR for returning the vehicle 100 to the parking route RP, using the stop position P1 before the turn-back position PT as the new turn-back position PT1. Then, the determination unit 15 determines whether the vehicle can return to the original parking route RP by using at least one of, for example, the stop position P1, the yaw angle of the vehicle 100 at the stop position P1, the return route RR being a travel route for returning the vehicle 100 to the original parking route RP, the minimum turning radius of the vehicle 100, the obstacles around the vehicle 100, the parking frame F, and the road width around the vehicle 100.

In the example shown in FIG. 7, for example, in the case of the turning radius R being the minimum turning radius of the vehicle 100 and the obstacle such as a parked vehicle or a wall being present on the right side of the parking frame F, the vehicle 100 cannot be moved to the position P2, therefore, this return route RR cannot be adopted. In this case, in step S706, the vehicle control device 10 determines, for example, by the determination unit 15, that the vehicle cannot return to the original parking route RP (NO).

Further, the case is considered that there is no obstacle on the right side of the parking frame F and the vehicle 100 is allowed to pass the position P2. In this case, if the yaw angle of the vehicle at position P3 is within the permissible range or if the vehicle 100 is allowed to move backward up to the position P4, in step S706, the vehicle control device 10 may determine, for example, by the determination unit 15, that the vehicle can return to the original parking route RP (YES).

Further, if the yaw angle of the vehicle 100 at the position P3 is out of the permissible range or if the vehicle 100 cannot move backward up to the position P4 due to the presence of an obstacle or the like, in step S706, the vehicle control device 10 may determine, for example, by the determination unit 15, that the vehicle cannot return to the original parking route RP (NO).

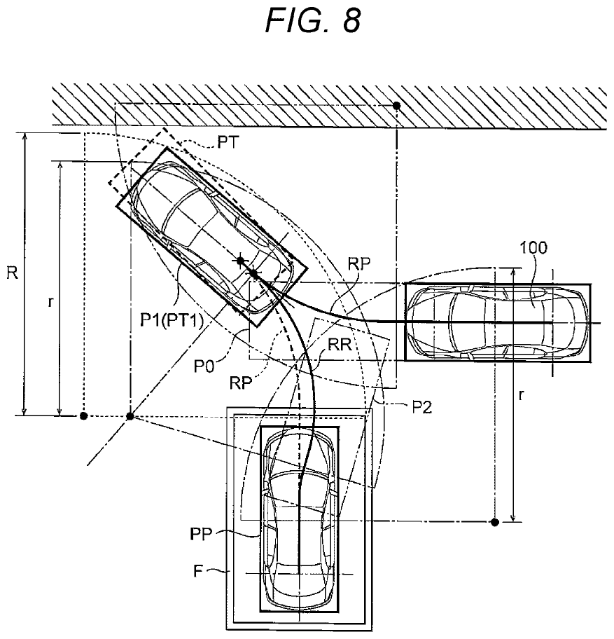

FIG. 8 is a plan view showing a return route RR for returning the vehicle to the original parking route RP by moving the vehicle 100 backward while turning the vehicle at a turning radius r smaller than the initial turning radius R of the parking route RP from the stop position P1 shown in FIG. 6. For example, as shown in FIG. 8, it is assumed that the minimum turning radius of the vehicle 100 is the turning radius r smaller than the turning radius R of the original parking route RP. In this case, as in the example shown in FIG. 7, in order to return the vehicle 100 to the parking route RP, the vehicle is moved backward up to the position P2 where the yaw angle of the vehicle 100 becomes larger than 90 degrees with respect to that at the start position P0.

Further, at the position P2, the steering wheel is turned to the right, and the vehicle 100 is moved backward from the position P2 while turning at the minimum turning radius r. Then, before the parking position PP, the yaw angle of the vehicle 100 rotates at an angle of 90 degrees with respect to the yaw angle of the vehicle 100 at the start position P0 and becomes equal to the yaw angle of the vehicle 100 at the parking position PP. That is, in the example shown in FIG. 8, the vehicle 100 can be moved backward from the stop position P1 before the turn-back position PT and returned to the original parking route RP by the return route RR. In this case, the determination unit 15 determines in step S706 that the vehicle can be returned to the original parking route RP (YES).

If the determination unit 15 determines in step S706 that the vehicle can be returned to the original parking route RP (YES), the process returns to step S701, the route calculator does not calculate the new parking route, and the route selector 13 selects the original parking route RP.

Then, the travel controller 12 makes the vehicle 100 travel along the return route RR using the stop position P1 as the turn-back position PT, and returns the vehicle to the original parking route RP. Alternatively, the route calculator 11 calculates the new parking route, but the route selector 13 selects the original parking route RP. On the other hand, in step S706, if the determination unit 15 determines that the vehicle cannot return to the original parking route RP (NO) as described above, the process proceeds to step S707.

In step S707, the route selector 13 calculates the new parking route using the stop position P1 as the turn-back position PT. Then, the process proceeds to step S708. The new parking route includes, for example, a plurality of turn-back positions. More specifically, the new parking route in which the stop position P1 is set as the turn-back position PT includes, for example, a backward route from the stop position P1 to a first turn-back position before the parking frame, a forward route from the first turn-back position to a second turn-back position before the wall, and a backward route from the second turn-back position to the parking position PP.

In the following step S708, the vehicle control device 10 determines whether or not the new parking route can be calculated in step S707. For example, when the route calculator 11 calculates the new parking route in step S707, the vehicle control device 10 determines that the new parking route can be calculated (YES) in step S708. Then, the process proceeds to step S709.

In step S709, the vehicle control device 10 selects, by the route selector 13, the new parking route calculated by the route calculator 11 at the stop position P1 or the original parking route RP calculated by the route calculator 11 at the start position P0. Then, the process returns to step S701. Here, the route selector 13 selects a more appropriate parking route, for example, between the original parking route RP and the new parking route described above. The route selector 13 calculates the efficiency of the parking route based on at least one of, for example, the number of times the parking route is turned back, the estimated time required for the vehicle 100 to travel on the parking route, and the length of the parking route.

In step S709, the vehicle control device 10 may notify the occupants of the vehicle of the original parking route RP and the new parking route through, for example, the interface 17, the display device 30, and the speaker. In this case, the vehicle control device 10 may have the occupant input the selection result of the original parking route RP and the new parking route through, for example, the interface 17, and the touch panel of the display device 30 or the microphone. In this case, the route selector 13 selects the original parking route RP or the new parking route according to the selection result input to the interface 17 by the occupant. Then, the process returns to step S701.

After that, in step S701, the travel controller 12 makes the vehicle 100 travel from the stop position P1 along the parking route selected by the route selector 13. Here, the interface 17 notifies the occupant of the vehicle 100 of the selection result of the route selector 13 through, for example, the display device 30 or the speaker. Then, the travel controller 12 makes the vehicle 100 travel along the parking route selected by the route selector 13 after the interface 17 notifies the selection result of the route selector 13.

As described above, the vehicle control device 10 of the present embodiment includes the route calculator 11 that calculates the parking route RP of the vehicle 100, the travel controller 12 that makes the vehicle 100 travel along the parking route RP, and the route selector 13 that selects either the original parking route RP or the new parking route when the vehicle 100 traveling along the parking route RP stops at the stop position P1 before the turn-back position PT, the new parking route being calculated at the stop position P1. Then, the travel controller 12 makes the vehicle 100 travel from the stop position P1 along the parking route selected by the route selector 13.

With this configuration, when the vehicle control device 10 selects the new parking route, the vehicle 100 can be moved backward from the stop position P1 and parked at the parking position PP using the stop position P1 as the new turn-back position PT1. As a result, for example, when the occupant of the vehicle 100 feels danger at the stop position P1 before the turn-back position PT and stops the vehicle 100, the case in which the vehicle 100 moves forward from the stop position P1 against the intention of the occupant is avoided. Therefore, according to the present embodiment, there can be provided the vehicle control device 10 that can reduce the discomfort of the occupant during parking control.

Further, as described above, the vehicle control device of the present embodiment includes, for example, a determination unit 15 that determines whether or not the vehicle can return to the original parking route RP by setting the stop position P1 as the new turn-back position PT1. Then, when the determination unit 15 determines that the vehicle can return to the original parking route, the route calculator 11 does not calculate the new parking route and the route selector 13 selects the original parking route RP, or the route calculator 11 calculates the new parking route but the route selector 13 selects the original parking route RP. The travel controller 12, then, sets the stop position P1 as the turn-back position PT to make the vehicle 100 travel and return to the original parking route RP.

With this configuration, when the determination unit 15 determines that the vehicle can return to the original parking route, the vehicle 100 can be moved backward from the stop position P1 and parked at the parking position PP, and therefore, the vehicle control device 10 that can reduce the discomfort of the occupant during parking control can be provided. Further, in this case, because the route selector 13 does not need to calculate the new parking route, the amount of processing of the vehicle control device 10 can be reduced.

Further, in the vehicle control device 10 of the present embodiment, the determination unit 15 determines whether or not the vehicle can return to the original parking route RP by using at least one of, for example, the stop position P1, the yaw angle of the vehicle at the stop position P1, the return route RR being a travel route for returning the vehicle 100 to the original parking route RP, the minimum turning radius r of the vehicle 100, the obstacles around the vehicle 100, the parking frame F, and the road width around the vehicle 100. With this configuration, the determination unit 15 can more accurately and quickly determine whether or not the vehicle 100 can return to the parking route RP using the stop position P1 as the new turn-back position PT1.

Further, as described above, the vehicle control device 10 of the present embodiment includes the interface 17 that notifies the occupants of the vehicle 100 of the selection result of the route selector 13. Then, when the determination unit 15 determines that the vehicle cannot return to the original parking route RP, the route calculator 11 calculates the new parking route. The route selector 13 selects a more efficient parking route from the original parking route RP and the new parking route. Then, the travel controller 12 makes the vehicle 100 travel along the parking route selected by the route selector 13 after the interface 17 notifies the selection result of the route selector 13.

With this configuration, even when the route selector 13 selects the original parking route RP, the occupant of the vehicle 100 can know the selection result. Therefore, as described above, even if, for example, the occupant of the vehicle 100 feels danger at the stop position P1 before the turn-back position PT and stops the vehicle 100, the occupant can know in advance that the vehicle 100 is going move forward. Therefore, it becomes possible to reduce the discomfort of the occupant during parking control. Further, when the route selector 13 selects a more efficient parking route, it becomes possible to reduce the discomfort of the occupant during parking control and reduce the time and energy required for parking.

More specifically, in the vehicle control device 10 of the present embodiment, the route selector 13 calculates the efficiency of the parking route based on at least one of the number of turn-back positions included in the parking route, the estimated time required for the vehicle 100 to travel on the parking route, and the length of the parking route. With this configuration, it becomes possible to calculate and compare the parking efficiencies of two or more parking routes and select a parking route with higher parking efficiency.

Further, as described above, the vehicle control device 10 of the present embodiment includes the interface 17 that notifies the occupant of the vehicle 100 of the original parking route RP and the new parking route and into which the selection result of the original parking route RP and the new parking route can be input by the occupant. Then, the route selector 13 can be configured to select the original parking route RP or the new parking route according to the selection result by the occupant input to the interface 17.

With this configuration, for example, when the occupant of the vehicle 100 feels danger at the stop position P1 before the turn-back position PT and stops the vehicle 100, the case in which the vehicle 100 moves forward from the stop position P1 against the intention of the occupant is avoided. Therefore, according to the present embodiment, there can be provided the vehicle control device 10 that can reduce the discomfort of the occupant during parking control.

Further, in the vehicle control device 10 of the present embodiment, the interface 17 is configured to notify the occupant of information related to the parking efficiency of the original parking route RP and the new parking route. With this configuration, the occupant can select either the original parking route RP or the new parking route by using the parking efficiency as an index, and the discomfort of the occupant during parking control can be further reduced.

Further, in step S707, the route calculator 11 may not be able to calculate the new parking route. More specifically, for example, when the following vehicle is approaching the vehicle 100 at the stop position P1, there may be a case in which the new parking route for moving the vehicle 100 backward from the parking position P1 using the stop position P1 as the new turn-back position PT1 cannot be calculated, depending on the conditions such as the limitation by the road width and the parked vehicle adjacent to the parking position PP. In this case, the vehicle control device 10 determines in step S708 that the new parking route cannot be calculated (NO). Then, the process proceeds to step S710.

In step S710, the vehicle control device 10 determines, for example, whether or not the stop release of the vehicle 100 is performed by the travel controller 12. Specifically, for example, when the occupant understands that the vehicle 100 is going to move forward from the stop position P1 to the turn-back position PT and releases the brake, the travel controller 12 determines that the stop release of the vehicle 100 has been performed (YES). Then, the process proceeds to step S709. Further, for example, if the occupant does not allow the vehicle 100 to move forward from the stop position P1 to the turn-back position PT and continues pressing the brake pedal for a certain period of time, the travel controller 12 determines that the stop release of the vehicle 100 is not performed (NO). Then, the process proceeds to step S711.

Further, when a moving object such as another vehicle or a pedestrian around the vehicle 100 on the parking route RP as an obstacle by, for example, the monocular camera 22, the sonar 23, and the detector 14, the travel controller 12 stops the vehicle 100.

In this case, in step S710, when the detector 14 continuously detects the obstacle in the parking route RP on which the vehicle 100 travels for a certain period of time or longer, the vehicle control device 10 determines that the stop release is not performed (NO). Then, the process proceeds to step S711. Further, in step S710, when the obstacle is no longer detected by the detector 14 within a certain period of time, the vehicle control device 10 determines that the stop release is performed (YES). Then, the process proceeds to step S709.

In step S709, the vehicle control device 10 selects, for example, the original parking route RP by the route selector 13. Then, the process returns to step S701. As a result, the travel controller 12 can make the vehicle 100 travel along the original parking route RP and park the vehicle at the parking position PP.

In step S711, the vehicle control device 10 determines the presence of the occupant of the vehicle 100 by, for example, a seating sensor, the detector 14, and the determination unit 15. For example, if the determination unit 15 determines that the occupant is present (YES), the process proceeds to step S714. On the other hand, for example, if the determination unit 15 determines that the occupant is not present (NO), the process proceeds to step S712.

In step S712, the vehicle control device 10 returns the vehicle 100 to the start position P0 of the parking route RP by the travel controller 12. More specifically, the travel controller 12 moves the vehicle 100 backward along the forward route between the start position P0 and the stop position P1 of the original parking route RP. Then, the process proceeds to step S713.

In step S713, the vehicle control device 10 determines, for example, whether or not the vehicle 100 has reached the start position P0 by the travel controller 12. If it is determined that the vehicle 100 has not reached the start position P0 (NO), the process returns to step S712 and the travel controller 12 makes the vehicle 100 continue traveling. If it is determined that the vehicle 100 has reached the start position P0 (YES) by the travel controller 12, the process proceeds to step S714.

In step S714, the vehicle control device 10 terminates the control by the travel controller 12 in a state of, for example, the vehicle 100 being stopped by the control terminator 16. In the case of the occupant being on board the vehicle 100, the interface 17, the display device 30, and the speaker, for example, notify the occupant of the vehicle 100 of the termination of control.

As described above, the vehicle control device 10 of the present embodiment includes the detector 14 that detects an obstacle around the vehicle 100. Then, travel controller 12 is configured to, when the obstacle is detected by the detector 14 in the parking route RP on which the vehicle 100 travels, stop the vehicle 100 at the stop position before the obstacle. Further, the travel controller 12 is configured to make the vehicle 100 travel from the stop position when the obstacle is no longer detected by the detector 14. With this configuration, the vehicle control device 10 can safely park the vehicle 100 up to the parking position PP while avoiding a collision with the obstacle.

Further, the vehicle control device 10 of the present embodiment includes the control terminator 16 that terminates the control by the travel controller 12 in the state of the vehicle 100 being stopped when the vehicle 100 cannot travel on the original parking route RP and the new parking route cannot be calculated by the route calculator 11, and notifies the occupant of the vehicle 100 of the termination of control. With this configuration, the occupant of the vehicle 100 can move the vehicle 100 by oneself and park the vehicle at another parking position.

Further, in the vehicle control device 10 of the present embodiment, the travel controller 12 is configured to return the vehicle to the start position of the parking route RP when the vehicle 100 cannot travel on the original parking route RP, there is no occupant on the vehicle 100, and the new parking route cannot be calculated by the route calculator 11. With this configuration, it is possible to prevent the vehicle 100 from getting stuck in the middle of the parking route RP.

Although the embodiment of the vehicle control device according to the present disclosure has been described in detail with reference to the drawings, the specific configuration is not limited to the present embodiment, and even if the design changes and the like are made within the gist of the present disclosure, the changes and the like are included in the present disclosure.

### REFERENCE SIGNS LIST

11 route calculator
12 travel controller
13 route selector
14 detector
15 determination unit
16 control terminator
17 interface
100 vehicle
F parking frame
P0 start position
P1 stop position
R minimum turning radius
RP parking route
RR return route (travel route)
TP turn-back position
TP1 turn-back position

1. A vehicle control device comprising:
a route calculator that calculates a parking route of a vehicle;
a travel controller that makes the vehicle travel along the parking route; and
a route selector that selects an original parking route or a new parking route when the vehicle traveling along the parking route stops at a stop position before a turn-back position, the new parking route being calculated at the stop position,
wherein the travel controller makes the vehicle travel from the stop position along a parking route selected by the route selector.

2. The vehicle control device according to claim 1, further comprising a determination unit that determines whether the vehicle can return to the original parking route using the stop position as a turn-back position,
wherein, when the determination unit determines that the vehicle can return to the original parking route, the route calculator does not calculate a new parking route and the route selector selects the original parking route, or the route calculator calculates the new parking route but the route selector selects the original parking route, and the travel controller makes the vehicle travel using the stop position as the turn-back position to return to the original parking route.

3. The vehicle control device according to claim 2, further comprising an interface that notifies an occupant of the vehicle of a selection result of the route selector,
wherein, when the determination unit determines that the vehicle cannot return to the original parking route, the route calculator calculates a new parking route and the route selector selects a more efficient parking route between the original parking route and the new parking route, and the travel controller makes the vehicle travel along a parking route selected by the route selector after the interface notifies of the selection result.

4. The vehicle control device according to claim 3, wherein the route selector calculates an efficiency of a parking route based on at least one of a number of turn-back positions included in the parking route, an estimated time required for the vehicle to travel on the parking route, and a length of the parking route.

5. The vehicle control device according to claim 1, further comprising a detector that detects an obstacle around the vehicle,
wherein the travel controller stops the vehicle at a stop position before the obstacles when the obstacle is detected by the detector in a parking route on which the vehicle travels, and the travel controller makes the vehicle travel from the stop position when the obstacle is no longer detected by the detector.

6. The vehicle control device according to claim 1, further comprising a control terminator that terminates control by the travel controller in a state of the vehicle being stopped when the vehicle cannot travel on the original parking route and the route calculator cannot calculate a new parking route, and that notifies an occupant of the vehicle of termination of control.

7. The vehicle control device according to claim 1, wherein the travel controller is configured to return the vehicle to a start position of the original parking route when the vehicle cannot travel on the original parking route, there is no occupant on the vehicle, and a new parking route cannot be calculated by the route calculator.

8. The vehicle control device according to claim 2, wherein the determination unit determines whether or not the vehicle can return to the original parking route by using at least one of the stop position, a yaw angle of the vehicle at the stop position, a travel route for the vehicle to return to the original parking route, a minimum turning radius of the vehicle, obstacles around the vehicle, a parking frame, and a road width around the vehicle.

9. The vehicle control device according to claim 1, further comprising an interface that notifies an occupant of the vehicle of the original parking route and the new parking route and into which a selection result of the original parking route and the new parking route can be input by the occupant,
wherein the route selector selects the original parking route or the new parking route according to the selection result input to the interface by the occupant.

10. The vehicle control device according to claim 9, wherein the interface notifies the occupant of information regarding a parking efficiency of the original parking route and the new parking route.
